(19) United States
(12) Patent Application Publication
(10) Pub. No.: US 2007/0036956 A1
(43) Pub. Date: Feb. 15, 2007

(54) Interlayers comprising an ultraviolet curable layer

(75) Inventors: Wenjie Chen, Amherst, MA (US); John Joseph D'Errico, Glastonbury, CT (US)

Correspondence Address: BRENC LAW;ANDREW BRENC, P.O. BOX 155, ALBION, PA, 16401-0155, US

(73) Assignee: Solutia, Inc.

(21) Appl. No.: 11/204,084

(22) Filed: Aug. 15, 2005

(51) Int. Cl. B32B 27/30; B32B 27/42; B32B 27/08; C08F 2/46; B05D 7/00; B05D 3/12

(52) U.S. Cl. 428/212; 428/411.1; 428/524; 428/522; 427/487; 427/421.1; 427/355

(57) ABSTRACT

The present invention is in the field of interlayers for use in multiple layer glass panels, and more specifically, the present invention is in the field of multiple layer glass panel interlayers comprising an ultraviolet curable layer.

### FIELD OF THE INVENTION

The present invention is in the field of interlayers for use in multiple layer glass panels, and more specifically, the present invention is in the field of multiple layer glass panel interlayers comprising an ultraviolet curable layer.

### BACKGROUND

Poly(vinyl butyral) (PVB) is commonly used in the manufacture of polymer sheets that can be used as interlayers in light-transmitting laminates such as safety glass or polymeric laminates. Safety glass typically refers to a transparent laminate comprising a poly(vinyl butyral) sheet disposed between two panes of glass. Safety glass is often used to provide a transparent barrier in architectural and automotive openings. Its main function is to absorb energy, such as that caused by a blow from an object, without allowing penetration through the opening.

Interlayers for multiple layer glass panels have been conventionally manufactured using many different types of polymers and additives. For example, in addition to poly(vinyl butyral), polymers such as poly(ethylene-co-vinyl acetate), polyurethane, and ionomers have been used as interlayers in various glazing laminates. In many conventional applications, multiple layers of the same or different material are combined to form a multiple layer interlayer that has properties that cannot be attained with only a single layer.

Interlayers that are capable of reducing the level of sound that is transmitted through a multiple layer glass panel are often particularly desirable in applications such as automotive windshields and architectural glazing for noise reduction. Conventional attempts to provide interlayers having reduced sound transmission qualities have involved, among other things, the use of adjacent layers of polymer sheets having dissimilar physical properties. Examples include U.S. Pat. No. 5,190,826, which teaches the use of acetals of differing carbon length, and U.S. Pat. Application 2003/0139520, which teaches the use of differing polymerization degree. Two other applications, Japanese Patent 3,377,848 and U.S. Pat. No. 5,340,654, teach the use of residual acetate levels of at least 5% in one of two adjacent sheets as a compositional difference. Unfortunately many conventional interlayers require inefficient or expensive processing steps, such as coextrusion, to achieve a product having the desired characteristics, or result in a product that is difficult to manage.

Interlayers that are capable of providing high penetration resistance and high security performances are particularly desirable in applications such as architectural glazing for hurricane protection, burglary protection, bullet resistant, bomb blast protection, and the like. Traditional interlayers for the aforementioned applications normally include one or more layers of thick, stiff, tough materials, such as polycarbonate, ionomers, stiff poly(vinyl butyral) composites with PET, and the like. These kinds of interlayers are very difficult to handle, cut to desired size, and trim and laminate because of their stiffness, toughness, and thickness.

Accordingly, there is a need in the art for multiple layer glass panel interlayers that can be efficiently and inexpensively produced and that provide the desired sound reducing qualities and increase security and safety performance.

### SUMMARY OF THE INVENTION

The present invention provides multiple layer interlayers that can be used in multiple layer glass panel type applications to achieve many desirable characteristics, including to reduce the amount of sound transmitted through the panel, and, in some embodiments, to offer improved hurricane protection. This effect is achieved, in various embodiments of the present invention, by providing an interlayer having a polymer sheet comprising an ultraviolet curable polymer and a conventional polymer sheet, wherein the two sheets have dissimilar glass transition temperatures. In various embodiments, a poly(vinyl butyral) sheet is used in combination with a polymer sheet comprising an ultraviolet curable polymer to form a multiple layer interlayer having the desired characteristics. Other embodiments provide further variations in which further polymer sheets and/or polymer films are included in an interlayer. Also provided are methods for manufacturing such interlayers and incorporating the interlayer into multiple layer glass panels.

### DETAILED DESCRIPTION

According to the present invention, it has now been surprisingly discovered that superior sound suppression characteristics, hurricane resistance, and improved safety, among other desirable characteristics, can be imparted on multiple layer glass panels by incorporating a multiple layer interlayer into the panels, where the interlayer comprises a polymer sheet comprising an ultraviolet curable polymer.

By providing interlayers having a polymer sheet comprising an ultraviolet curable polymer, as described in detail herein throughout, sound transmission through multiple layer glass panels can be effectively reduced by, for example, up to about 7 decibels.

As used herein, an “interlayer” is any thermoplastic construct that can be used in glass applications, such as safety glass in windshields and architectural windows, and a “multiple layer” interlayer is any interlayer that is formed by combining two or more individual layers into a single interlayer.

In various embodiments of the present invention, a multiple layer interlayer comprises a polymer sheet comprising an ultraviolet curable polymer, as described in detail elsewhere herein, disposed in contact with a polymer stack. As used herein, a “polymer stack” means a single polymer sheet, as described in detail elsewhere herein, or multiple layers disposed in contact with each other wherein at least one of the multiple layers is a polymer sheet, and wherein the other layers can be polymer sheets, polymer films, or other conventional interlayer components. Arrangements of interlayers of the present invention therefore include those of the general description (polymer sheet comprising ultraviolet curable polymer)//(polymer stack), wherein the polymer stack can be, for example and without limitation, any of the following:
(polymer sheet)ₓ
(polymer film//polymer sheet)_{y}
(polymer sheet//polymer film)_{y}
(polymer film)_{z}

where x can be 1to 10 and preferably 1 to 4, and y can be 1 to 5, and prefererably 1or 2, and z can be 1 or 2 and is preferably 1.

In further embodiments of the present invention, a second polymer stack can be added to the polymer sheet comprising an ultraviolet curable polymer on the exposed surface, yielding interlayers having the configuration: (first polymer stack)//(polymer sheet comprising an ultraviolet curable polymer)//(second polymer stack). In these embodiments, the first polymer stack and the second polymer stack can be the same or different. In a simple example, a polymer sheet comprising an ultraviolet curable polymer can be disposed between two poly(vinyl butyral) polymer sheets to form a three layer interlayer.

In various embodiments of the present invention, a polymer sheet comprising an ultraviolet curable polymer and an adjacent polymer sheet in one or both polymer stacks have a difference in glass transition temperature (T_{g}) of at least 10° C., 20° C., or 30° C. In other embodiments, the polymer sheets have a difference of up to 50° C. The glass transition temperature of the polymer sheet comprising an ultraviolet curable polymer can, in various embodiments, be from −50° C. to 20° C., −30° C. to 20° C., −10° C. to 20° C., 0° C. to 20° C., 0° C. to 18° C. or 0° C. to 15° C., with the one or more adjacent polymer sheet layers having at least the glass transition temperature differences noted above, and, in various embodiments, can have a glass transition temperature of, for example, −5° C. to 15° C. In yet further embodiments, polymer sheets comprising an ultraviolet curable polymer have a glass transition temperature of less than 80° C., less than 70° C., or less than 50° C.

Glass transition temperature of polymer sheet comprising a UV curable polymer can be higher than the adjacent polymer sheet (for example, poly(vinyl butyral) layers) for hurricane protection and other high security applications. The Tg of the polymer sheet comprising a UV curable polymer can be up to, for example, 100° C. or higher.

The layered interlayer constructs of the present invention are particularly useful when a polymer sheet comprising an ultraviolet curable polymer having a relatively low glass transition temperature is disposed between two polymer sheets having higher glass transition temperatures, because the outside polymer sheets can be formed so as to have readily manageable surface tackiness characteristics relative to the ultraviolet cured polymer having a relatively low glass transition temperature.

In various embodiments of the present invention, multiple layer interlayers of the present invention, when laminated between two 2 millimeter thick panes of glass, reduce the transmission of sound through the laminated glass panel by at least 1 decibel, 2 decibels, 3 decibels, or 4 decibels relative to a comparable laminated glass panel having a single conventional interlayer with an equivalent thickness of the multiple layer interlayer of the present invention, wherein the single conventional interlayer has a composition that is the same as any of the polymer sheets of the interlayer of the present invention to which it is compared.

In addition to the acoustic type interlayers just described, multiple layer embodiments having little or no difference between the glass transition temperatures of two or more layers are within the scope of the present invention. For example, a polymer sheet comprising an ultraviolet curable polymer can be disposed between two layer of poly(vinyl butyral), wherein all three layers have the same or close to the same glass transition temperatures.

In addition to the three layer embodiments described herein, further embodiments include interlayers having more than three layers in which further polymer sheets comprising an ultraviolet curable polymer are used. For example, an interlayer having the following structure can be readily prepared: polymer sheet// polymer sheet comprising an ultraviolet curable polymer //polymer sheet//polymer sheet comprising an ultraviolet curable polymer//polymer sheet.

Other conventional layers, as are known in the art, can be incorporated into the interlayers of the present invention. For example, polymer films (described in detail elsewhere herein) such as polyesters like poly(ethylene terephthalate) (PET), poly(ethylene terephthalate) having a metallized layer, an infrared reflecting stack, or other performance layer deposited thereon, can be included between any two layers of polymer sheets of the present invention.

In addition to the interlayers provided herein, the present invention also provides methods of reducing the level of sound through an opening, comprising the step of disposing in the opening a multiple layer glass panel comprising any of the interlayers of the present invention.

The present invention also includes methods of manufacturing a multiple layer glazing, comprising laminating any of the interlayers of the present invention between two rigid, transparent panels, as are known in the art, such as glass or acrylic layers.

The present invention also includes multiple layer glass panels, such as windshields and architectural windows, comprising a multiple layer interlayer of the present invention.

Also included are multiple layer glazing panels having plastics, such as acrylics, or other suitable materials in place of the glass panels.

Also included within the scope of the present invention are methods of manufacturing multiple layer interlayers comprising polymer sheets comprising an ultraviolet curable polymer and a conventional polymer sheet, as described in detail in the “polymer sheets comprising an ultraviolet curable polymer” section, below.

Polymer Film

As used herein, a “polymer film” means a relatively thin and rigid polymer layer that functions as a performance enhancing layer. Polymer films differ from polymer sheets, as used herein, in that polymer films do not themselves provide the necessary impact resistance and glass retention properties to a multiple layer glazing structure, but rather provide performance improvements, such as infrared absorption character. Poly(ethylene terephthalate) is most commonly used as a polymer film.

Polymer films used in the present invention can be any suitable film that is sufficiently rigid to provide a relatively flat, stable surface, for example those polymer films conventionally used as a performance enhancing layer in multiple layer glass panels. The polymer film is preferably optically transparent (i.e. objects adjacent one side of the layer can be comfortably seen by the eye of a particular observer looking through the layer from the other side), and usually has a greater, in some embodiments significantly greater, tensile modulus regardless of composition than that of the adjacent polymer sheet. In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers and the like. In various embodiments, the polymer film comprises materials such as re-stretched thermoplastic films having the noted properties, which include polyesters. In various embodiments, the polymer film comprises or consists of poly(ethylene terephthalate), and, in various embodiments, the poly(ethylene terephthalate) has been biaxially stretched to improve strength, and/or has been heat stabilized to provide low shrinkage characteristics when subjected to elevated temperatures (e.g. less than 2% shrinkage in both directions after 30 minutes at 150° C.).

In various embodiments, the polymer film can have a thickness of 0.013 millimeters to 0.25 millimeters, 0.025 millimeters to 0.1 millimeters, or 0.04 to 0.06 millimeters. The polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers. Various coating and surface treatment techniques for poly(ethylene terephthalate) film and other polymer films that can be used with the present invention are disclosed in published European Application No. 0157030. Polymer films of the present invention can also include a hardcoat and/or and antifog layer, as are known in the art.

Polymer Sheet

As used herein, a “polymer sheet” means any polymer composition formed by any suitable method into a thin layer that is suitable alone, or in stacks of more than one layer, for use as an interlayer that provides adequate penetration resistance and glass retention properties to laminated glazing panels. Plasticized poly(vinyl butyral) is most commonly used to form polymer sheets.

The polymer sheet can comprise any suitable polymer, and, in a preferred embodiment, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, polyvinyl chloride, poly(ethylene-co-vinyl acetate), partially neutralized ethylene/(meth)acrylic copolymers, ionomers, combinations thereof, and the like. In further embodiments the polymer sheet comprises poly(vinyl butyral) and one or more other polymers.

Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) with butyraldehyde in the presence of an acid catalyst, followed by neutralization of the catalyst, separation, stabilization, and drying of the resin.

Details of suitable processes for making poly(vinyl butyral) resin are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, ³rd edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols.

In various embodiments, the polymer sheet comprises poly(vinyl butyral) having a molecular weight greater than 30,000, 40,000, 50,000, 55,000, 60,000, 65,000, 70,000, 120,000, 250,000, or 350,000 grams per mole (g/mole or Daltons). Small quantities of a dialdehyde or trialdehyde can also be added during the acetalization step to increase molecular weight to greater than 350 Daltons (see, for example, U.S. Pat. Nos. 4,874,814; 4,814,529; and 4,654,179). As used herein, the term “molecular weight” means the weight average molecular weight.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779, and C₆ to C₈ adipate esters, such as hexyl adipate. In preferred embodiments, the plasticizer is triethylene glycol di-(2-ethylhexanoate).

Polymer sheets can comprise 20 to 60, 25 to 60, 20 to 80, 10 to 70, or 5 to 100 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

Adhesion control agents can also be included in the polymer sheets of the present invention to impart the desired adhesiveness. These agents can be incorporated into the outer sheets in a three polymer sheet embodiment, for example. Any of the ACAs disclosed in U.S. Pat. 5,728,472 can be used. Additionally, residual sodium acetate and/or potassium acetate can be adjusted by varying the amount of the associated hydroxide used in acid neutralization. In various embodiments, polymer sheets of the present invention comprise, in addition to sodium acetate and/or potassium acetate, magnesium bis(2-ethyl butyrate)(chemical abstracts number 79992-76-0). The magnesium salt can be included in an amount effective to control adhesion of the polymer sheet to glass.

Additives may be incorporated into the polymer sheet to enhance its performance in a final product. Such additives include, but are not limited to, plasticizers, dyes, pigments, stabilizers (e.g., ultraviolet stabilizers), antioxidants, flame retardants, other IR absorbers, UV absorbers, anti-block agents, combinations of the foregoing additives, and the like, as are known in the art.

Agents that selectively absorb light in the visible or near infrared spectrum can be added to any of the appropriate polymer sheets. Agents that can be used include dyes and pigments such as LaB6, indium tin oxide, antimony tin oxide, or lanthanum hexaboride.

One exemplary method of forming a poly(vinyl butyral) layer comprises extruding molten poly(vinyl butyral) comprising resin, plasticizer, and additives and then forcing the melt through a sheet die (for example, a die having an opening that is substantially greater in one dimension than in a perpendicular dimension). Another exemplary method of forming a poly(vinyl butyral) layer comprises casting a melt from a die onto a roller, solidifying the melt, and subsequently removing the solidified melt as a sheet. As used herein, “melt” refers to a mixture of resin with a plasticizer and, optionally, other additives. In either embodiment, the surface texture at either or both sides of the layer may be controlled by adjusting the surfaces of the die opening or by providing texture at the roller surface. Other techniques for controlling the layer texture include varying parameters of the materials (for example, the water content of the resin and/or the plasticizer, the melt temperature, molecular weight distribution of the poly(vinyl butyral), or combinations of the foregoing parameters). Furthermore, the layer can be configured to include spaced projections that define a temporary surface irregularity to facilitate the de-airing of the layer during lamination processes after which the elevated temperatures and pressures of the laminating process cause the projections to melt into the layer, thereby resulting in a smooth finish.

The parameters for the polymer sheet described above apply as well to any layer in a multiple layer construct of the present invention that is a poly(vinyl butyral) type layer.

Polymer Sheets Comprising an Ultraviolet Curable Polymer

As used herein, a “polymer sheet comprising an ultraviolet curable polymer” means any polymer sheet that is substantially composed of a polymer that is formed from a resin that can be cured through exposure to ultraviolet radiation. In various embodiments, these sheets can have components in addition to the ultraviolet curable polymer, and can include small amounts of performance improving additives, other polymeric components, curing catalysts, and other agents that are conventionally used in multiple layer interlayers.

Examples of ultraviolet curable resins that can be used to form polymer sheets of the present invention include those conventional ultraviolet curable resins that, when formed into a layer and cured, provide appropriate optical and physical qualities. These qualities can include, for example and without limitation, high light transmission, compatibility with adjacent components, stability over time, and the like. Specific examples include UVEKOLTM ™ A and UVEKOLTM ™ S resins (UCB GROUP, Smyrna, Ga), SaoSA ultraviolet curable resins (SaoSa UV-S and SaoSa UV-B resins, SaoSA Technology Companies, Limited, China), and mixtures of the foregoing.

Ultraviolet curable resins can include an acrylic oligomer, an acrylic monomer, combinations of two or more acrylic monomers, combinations of two or more acrylic oligomers, and mixtures of the foregoing in addition to a photoinitiator or a combination of two or more photoinitiators.

Acrylic monomers include, but are not limited to, methyl methacrylate, ethyl methacrylate, methacrylic acid, 2-ethylhexyl acrylate, acrylic acid, isobornyl methacrylate, ethylene glycol dimethacrylate, tetraethylene glycol dimethacrylate, diethylene glycol dimethacrylate, and the like.

Acrylic oligomers include, but are not limited to, urethane acrylate, polyester acrylates, epoxy acrylates, full acrylics (acrylated (co)polymers of (meth)acrylic esters), amino acrylates (used as a photoaccelerator in the photoinitiator system), vinyl ethers, and the like.

In various embodiments of the present invention, an ultraviolet curable resin comprises between 5% and 15%, inclusive, weight/weight of urethane acrylate, between 70% and 80%, inclusive, weight/weight of ethylhexyl acrylate, and between 10% and 20%, inclusive, weight/weight of acrylic acid.

Photoinitiators include, for example and without limitation, benziketals, dialkoxyacetophenones, hydroxyalkylphenyl ketones, benzoyl oxime esters, benzoyl phosphine oxides, morpholino ketones and amino ketones, aryl-aryl sulphides, sulphoxides, sulphonyl ketones, and the like.

Polymer sheets comprising ultraviolet curable polymers, according to one method of the present invention, are formed directly on another, already formed, polymer sheet or polymer film by applying an ultraviolet curable resin onto the polymer sheet or film, and then exposing the layer of resin to ultraviolet radiation to cure the resin and form a polymer sheet comprising an ultraviolet curable polymer. The resulting two layer structure can then be used as an interlayer, or further layers can be added and laminated to form an interlayer. For example, another polymer sheet can be disposed in contact with the polymer sheet comprising an ultraviolet curable polymer, and the three layer structure can then be laminated to form a three layer interlayer that has the polymer sheet comprising an ultraviolet curable polymer laminated between two polymer sheets. In one preferred embodiment, the polymer sheet comprising an ultraviolet curable polymer is disposed between two polymer sheets comprising plasticized poly(vinyl butyral).

Ultraviolet curable resin can be applied to polymer sheets in any suitable manner, including slot die coating, knife and blade coating, spray, and so on. Resin can also be directly poured into the space between two polymer sheets comprising plasticized poly(vinyl butyral) or poly(ethylene terephthalate), between a polymer sheet comprising plasticized poly(vinyl butyral) and another polymer sheet comprising poly(ethylene terephthalate).

Polymer sheets, polymer films, and polymer sheets comprising an ultraviolet curable polymer, among other layers, can be combined to form a multiple layer interlayer. Fabrication of a multiple layer interlayer can be accomplished by using known techniques in the art, such as independently producing three layers of polymer sheet, and then laminating the three sheets together under appropriate conditions to yield a single, multiple layer interlayer.

In various embodiments, the interlayers of the present invention can have total thicknesses of 0.1 to 3.0 millimeters, 0.2 to 2.0 millimeters, 0.25 to 1.75 millimeters, and 0.3 to 1.5 millimeters (mm), although other thicknesses, including greater thicknesses, are within the scope of the present invention. The individual polymer sheets of a multiple layer interlayer can have, for example, approximately equal thicknesses that, when added together, result in the total thickness ranges given above. Of course, in other embodiments, the thicknesses of the layers can be different, and can still add to the total thicknesses given above.

The following paragraphs describe various techniques that can be used to measure the characteristics of the polymer sheet.

The clarity of a polymer sheet, can be determined by measuring the haze value, which is a quantification of the scattered light by a sample in contrast to the incident light. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C., at an observer angle of 2 degrees. In various embodiments of the present invention, percent haze is less than 5%, less than 3%, and less than 1%.

The visible transmittance can be quantified using a UV-Vis-NIR spectrophotometer such as the Lambda 900 made by Perkin Elmer Corp. by methods described in international standard ISO 9050:1990. In various embodiments, the transmittance through a polymer sheet of the present invention is at least 60%, at least 70%, or at least 80%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17.8° C. (0° F.) and manually pummeled with a hammer to break the glass. All broken glass that is not adhered to the poly(vinyl butyral) layer is then removed, and the amount of glass left adhered to the poly(vinyl butyral) layer is visually compared with a set of standards. The standards correspond to a scale in which varying degrees of glass remain adhered to the poly(vinyl butyral) layer. In particular, at a pummel standard of zero, no glass is left adhered to the poly(vinyl butyral) layer. At a pummel standard of 10, 100% of the glass remains adhered to the poly(vinyl butyral) layer. Poly(vinyl butyral) layers of the present invention can have, for example, a pummel value of between 3 and 10.

By virtue of the present invention, it is now possible to provide multiple layer interlayers that incorporate ultraviolet curable polymers to reduce sound transmission and provide other desirable characteristics and that are readily incorporated into multiple layer constructs, such as laminated glass panels for windshields and architectural windows.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising an ultraviolet curable polymer sheet of various thicknesses comprising various amounts of photoinitiators to form many permutations that are within the scope of the present invention but that would be exceedingly cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

I claim:

1. A polymer interlayer comprising:
a polymer stack comprising a first polymer sheet, wherein said first polymer sheet comprises a thermoplastic polymer; and,
a second polymer sheet, wherein said second polymer sheet comprises an ultraviolet curable polymer and is disposed in contact with said first polymer sheet.

2. The polymer interlayer of claim 1, wherein said first polymer sheet comprises poly(vinyl butyral).

3. The polymer interlayer of claim 1, wherein said second polymer sheet comprises an ultraviolet curable polymer selected from the group consisting of methyl methacrylate, ethyl methacrylate, methacrylic acid, 2-ethylhexyl acrylate, acrylic acid, isobomyl methacrylate, ethylene glycol dimethacrylate, tetraethylene glycol dimethacrylate, diethylene glycol dimethacrylate, urethane acrylate, polyester acrylate, epoxy acrylate, full acrylics, amino acrylate, vinyl ether, and combinations of the foregoing.

4. The polymer interlayer of claim 1, wherein said second polymer sheet comprises an ultraviolet curable polymer selected from the group consisting of urethane acrylate, ethylhexyl acrylate, acrylic acid, and combinations of the foregoing.

5. The polymer interlayer of claim 1, wherein said second polymer sheet is disposed in contact with said second polymer sheet.

6. The polymer interlayer of claim 1, wherein said polymer stack further comprises a polymer film.

7. The polymer interlayer of claim 1, wherein the glass transition temperature of said second polymer sheet is less than 80° C. and the glass transition temperature of said first polymer sheet is at least 20° C.

8. The polymer interlayer of claim 1, wherein the glass transition temperature of said second polymer sheet is less than 20° C. and the glass transition temperature of said first polymer sheet is at least 20° C.

9. The polymer interlayer of claim 1, further comprising a second polymer stack disposed in contact with said second polymer sheet, wherein said second polymer stack comprises a third polymer sheet comprising a plasticized thermoplastic polymer.

10. The polymer interlayer of claim 9, wherein said third polymer sheet comprises poly(vinyl butyral) and has a glass transition temperature above 20° C.

11. The polymer interlayer of claim 10, wherein said third polymer sheet is disposed in contact with said second polymer sheet.

12. A method for manufacturing an interlayer, comprising:
providing a first polymer sheet;
forming a layer of ultraviolet curable resin on said first polymer sheet; and,
curing said layer of ultraviolet curable resin to form a second polymer sheet.

13. The method of claim 12, wherein said first polymer sheet comprises poly(vinyl butyral).

14. The method of claim 13, wherein said ultraviolet curable polymer is selected from the group consisting of methyl methacrylate, ethyl methacrylate, methacrylic acid, 2-ethylhexyl acrylate, acrylic acid, isobomyl methacrylate, ethylene glycol dimethacrylate, tetraethylene glycol dimethacrylate, diethylene glycol dimethacrylate, urethane acrylate, polyester acrylate, epoxy acrylate, full acrylic, amino acrylate, vinyl ether, and combinations of the foregoing.

15. The method of claim 13, wherein said ultraviolet curable polymer is selected from the group consisting of urethane acrylate, ethylhexyl acrylate, acrylic acid, and combinations of the foregoing.

16. The method of claim 12, wherein said forming comprises applying ultraviolet curable reason on said first polymer sheet by slot die coating, knife and blade coating, spray coating, or gravure coating.

17. The method of claim 12, wherein said forming comprises knife and blade coating or slot die coating.

18. The method of claim 12, further comprising disposing a third polymer sheet in contact with said second polymer sheet and laminating said first polymer sheet, said second polymer sheet, and said third polymer sheet.

19. The method of claim 12, further comprising disposing a polymer film in contact with said second polymer sheet, disposing a third polymer sheet in contact with said polymer film, and laminating said first polymer sheet, said second polymer sheet, said polymer film, and said third polymer sheet.

20. The method of claim 12, wherein the glass transition temperature of said second polymer sheet is less than 80° C. and the glass transition temperature of said first polymer sheet is at least 20° C.
